(19) United States
(12) Patent Application Publication
(10) Pub. No.: US 2017/0126282 A1
(43) Pub. Date: May 4, 2017

(54) SENSOR DEVICES AND SYSTEMS FOR POWERING SAME INCLUDING EXAMPLES OF BODY-AREA NETWORKS POWERED BY NEAR-FIELD COMMUNICATION DEVICES

(71) Applicant: University of Washington, Seattle, WA (US)

(72) Inventors: Joshua Fromm, Seattle, WA (US); Shwetak N. Patel, Seattle, WA (US); Matthew S. Reynolds, Seattle, WA (US)

(73) Assignee: University of Washington, Seattle, WA (US)

(21) Appl. No.: 15/343,001

(22) Filed: Nov. 3, 2016

Related U.S. Application Data
(60) Provisional application No. 62/250,384, filed on Nov. 3, 2015.

(51) Int. Cl. H04B 5/00; H04B 13/00; H04W 4/00

(52) U.S. Cl. CPC H04B 5/0037; H04W 4/008; H04B 13/005; H04B 5/0043

(57) ABSTRACT

Example systems described herein may include one or more sensor devices that may be powered by a power device. The power may be transmitted from the power device to the sensor devices through a waveguide (e.g. a body). In some examples, the power device may be implemented using a near-field communication device (e.g. a mobile phone configured for near-field communication (NFC)). Magnetic fields generated by near-field communication devices may be transduced into electric fields and applied to a waveguide (e.g. a body) for transmission to the sensor devices. The sensor devices may harvest power from the signals received from the waveguide (e.g. the body).

### CROSS-REFERENCE TO RELATED APPLICATION(S)

This application claims the benefit under 35 U.S.C. §119 of the earlier filing date of U.S. Provisional Application Ser. No. 62/250,384 filed Nov. 3, 2015, the entire contents of which are hereby incorporated by reference in their entirety for any purpose.

### TECHNICAL FIELD

Examples described herein include sensor devices and systems for powering the same. Examples of body-area networks powered by near-field communication devices are described.

### BACKGROUND

The proliferation of smartphones has triggered a health sensing revolution. Smartphone paired devices such as Fitbits and more recently smartwatches have allowed users to monitor their health with an unprecedented level of continuity, detail, and personalization. However, these devices typically have sophisticated hardware which causes them to be expensive. The restrictive price requires that current health sensors take measurements at only a single point on the body since only one device can be reasonably purchased per user.

Although the use of the human body as a medium of communication has been known for over a decade, the rise of the internet of everything has transformed body area networks from an academic novelty to an interesting field for development. Noting that the human body has a high dielectric constant and consequently a high permittivity to electric fields, researchers have shown that capacitive coupling allows the body to be used as a medium of communication. These body area network (BAN) advancements allow networks of inexpensive battery-less sensors to be connected, but require a bulky and expensive signal generator and data aggregator.

For example, early implementations of BANs utilized electrostatic coupling between a transmitter, receiver, and ground plane to send data. It was shown that using this same technique, power could be extracted from the data sent by the transmitter module, allowing a single powered device and multiple unpowered devices that harvest energy from the BAN. However, the use of electrostatic coupling as a method of signal propagation requires that devices in the BAN be coupled both to the body and a shared ground, which may prevent minimal distributed on-body sensors from being used.

### SUMMARY

Examples of systems are described herein. An example system may include a power device and/or a sensor device. The power device may include a power source and a power device electrode coupled to the power source and configured for electrical connection to a waveguide.

In some examples, the sensor device may include sensor circuitry; a first sensor device electrode configured for electrical connection to the waveguide; a second sensor device electrode positioned to provide a return path from the sensor device to the power device; and/or power harvesting circuitry coupled to the sensor circuitry, the first sensor device electrode, and the second sensor device electrode.

In some examples, the power harvesting circuitry may be configured to at least partially power the sensor circuitry using power harvested from the power source through at least the first sensor device electrode.

In some examples, the waveguide may include a body.

In some examples, the sensor device may be configured for placement on the waveguide.

In some examples, the sensor device may include electrical components supported by a substrate having an adhesive region. In some examples, the adhesive region is configured for application to the waveguide.

In some examples, the power device may include a mobile phone. In some examples, the power source may include a battery. In some examples, the power device may include an electronic device configured for near-field communication.

In some examples, the power source may include a battery of the electronic device, and the power device electrode may be coupled to a transducing coil of the electronic device.

In some examples, the transducing coil and the power device electrode may be provided in a case for the electronic device.

In some examples, the sensor device may be positioned at least 20 cm away from the power device on the waveguide.

In some examples, the second sensor device electrode may be configured to be positioned above the waveguide in proximity to the first sensor device electrode and the return path may be through an environment.

In some examples, the second sensor device electrode may be configured to provide the return path when a portion of the waveguide contacts the second sensor device electrode.

In some examples, the first sensor device electrode and the second sensor device electrode may be separated by a distance such that a different resistance is provided between the first sensor device electrode and the power device than a resistance between the second sensor device electrode and the power device.

In some examples, the sensor device is configured for implant into the waveguide. In some examples, the waveguide may include a body and the sensor circuitry may include a dielectric pressure sensor configured to detect a pulse rate of the body. In some examples, the waveguide may include a body and the sensor circuitry may include an ECG sensor configured to detect a heart rate of the body.

Examples of sensor devices are described herein. An example sensor device may include a flexible substrate configured to adhere to a body, sensor circuitry supported by the flexible substrate, a first sensor device electrode supported by the flexible substrate, the first sensor device electrode configured for placement against a skin of the body when the flexible substrate is adhered to the body, a second sensor device electrode positioned to provide a return path from the sensor device to a power source, and/or power harvesting circuitry coupled to the sensor circuitry, the first sensor device electrode, and the second sensor device electrode. In some examples, the power harvesting circuitry may be configured to at least partially power the sensor circuitry using power harvested from the power source through at least the first sensor device electrode.

In some examples, the second sensor device electrode may be configured to provide the return path when a portion of the body contacts the second sensor device electrode.

In some examples, the second sensor device electrode may be positioned on an opposite side of the flexible substrate from the first sensor device electrode.

In some examples, the sensor circuitry may include a dielectric pressure sensor, an ECG sensor, an accelerometer, or combinations thereof.

In some examples, a sensor device may include communication circuitry configured to transmit data collected by the sensor circuitry, receive data, or combinations thereof. In some examples, the communication circuitry may include a backscatter transmitter.

Examples of cases are described herein. In some examples, a case may include a housing configured for attachment to an electronic device configured for near-field communication, a transducing coil configured to receive a magnetic field provided by the near-field communication, and electrodes positioned to provide an alternating electric field based on the magnetic field received at the transducing coil.

In some examples, the electronic device may include a mobile phone.

In some examples, the transducing coil is positioned on a first side of the housing and the electrodes are positioned on a second side of the housing.

In some examples, the electrodes may be positioned to be in electrical communication with a body when the case is positioned proximate the body.

Examples of methods are described herein. An example method may include positioning a near-field communication device proximate a body, transducing a magnetic field of the near-field communication device to an electric field and coupling the electric field to the body, and powering a sensor device positioned on or in the body using the electric field.

In some examples, powering the sensor device may include touching an electrode of the sensor device.

In some examples, positioning the near-field communication device proximate the body may include placing the near-field communication device in a pocket.

In some examples, transducing the magnetic field of the near-field communication device to the electric field may include using a transducing coil in a case coupled to the near-field communication device.

In some examples, methods may include coupling the electric field to the body.

In some examples, methods may include extracting at least a portion of the electric field from the body using the sensor device.

In some examples, methods may include transmitting data from the sensor device to the near-field communication device. In some examples, the transmitting may include backscattering.

### BRIEF DESCRIPTION OF THE DRAWINGS

FIG. 1 is a schematic illustration of a system including multiple sensor devices on a body powered by a power device arranged in accordance with examples described herein.

FIG. 2 is a schematic illustration of a sensor device arranged in accordance with examples described herein.

FIG. 3 A-FIG. 3C are schematic illustrations of sensor devices positioned on an arm in accordance with examples described herein.

FIG. 4 is a schematic illustration of example forward and return paths arranged in accordance with examples described herein.

FIG. 5 is a schematic illustration of a circuit representation of an example system arranged in accordance with examples described herein.

FIG. 6 is a schematic illustration of a circuit representation of an example system arranged in accordance with examples described herein.

FIG. 7 A and FIG. 7B are schematic illustrations of a case arranged in accordance with examples described herein.

FIG. 8 is a flowchart illustrating a method arranged in accordance with examples described herein.

### DETAILED DESCRIPTION

Certain details are set forth below to provide a sufficient understanding of embodiments of the invention. However, it will be clear to one skilled in the art that embodiments of the invention may be practiced without various ones of these particular details. In some instances, well-known circuits, control signals, timing protocols, computing systems, sensors, sensor operations, communication components, and software operations have not been shown in detail in order to avoid unnecessarily obscuring the described embodiments of the invention.

A distributed network of on-body sensors may be desirable to gather medical data from points all around the body, which may create a much more meaningful personal health profile than is currently available using a single sensor. Using multiple sensors may give rise to engineering challenges. For a multi-sensor system to be economical, each sensor should desirably be inexpensive and consequently have simple hardware. Additionally, the difficulty of charging and monitoring the many batteries of a multi-sensor means that the sensors should desirably be wirelessly powered for some applications.

Moreover, examples described herein may utilize one or more mobile devices (e.g. smartphones) to power nodes in a body-area network (BAN). Accordingly, examples described herein may address previous limitations of both personal health sensing and BANs, enabling a new generation of internet of everything devices.

Examples described herein may implement body-area networks (BANs). For example, a distributed network of low cost health sensing nodes placed on the body may be provided that use the human body to propagate a smartphone's NFC signal for power and/or communication.

Example systems described herein may include one or more sensor devices that may be powered by a power device. The power may be transmitted from the power device to the sensor devices through a waveguide (e.g. a body). In some examples, the power device may be implemented using a near-field communication device (e.g. a mobile phone configured for near-field communication (NFC)). Magnetic fields generated by near-field communication devices may be transduced into electric fields and applied to a waveguide (e.g. a body) for transmission to the sensor devices. The sensor devices may harvest power from the signals received from the waveguide (e.g. the body). To facilitate power harvesting, the sensor devices may have at least two electrodes such that there is both a forward and return path to the power device (e.g. a forward path between the power device and a first electrode and a return path between a second electrode and the power device). In this manner, power may be harvested. Examples described herein may describe the use of a body (including portions of a body) as a waveguide used to transmit signals from which power may be harvested, although other waveguides may be used in other examples.

While forward and return paths for electrical signals are described herein, it is to be understood that the forward and return path designations may be swapped in other examples—such that the path referred to as the forward path may be a return path and the path referred to as the return path may be the forward path, and vice versa.

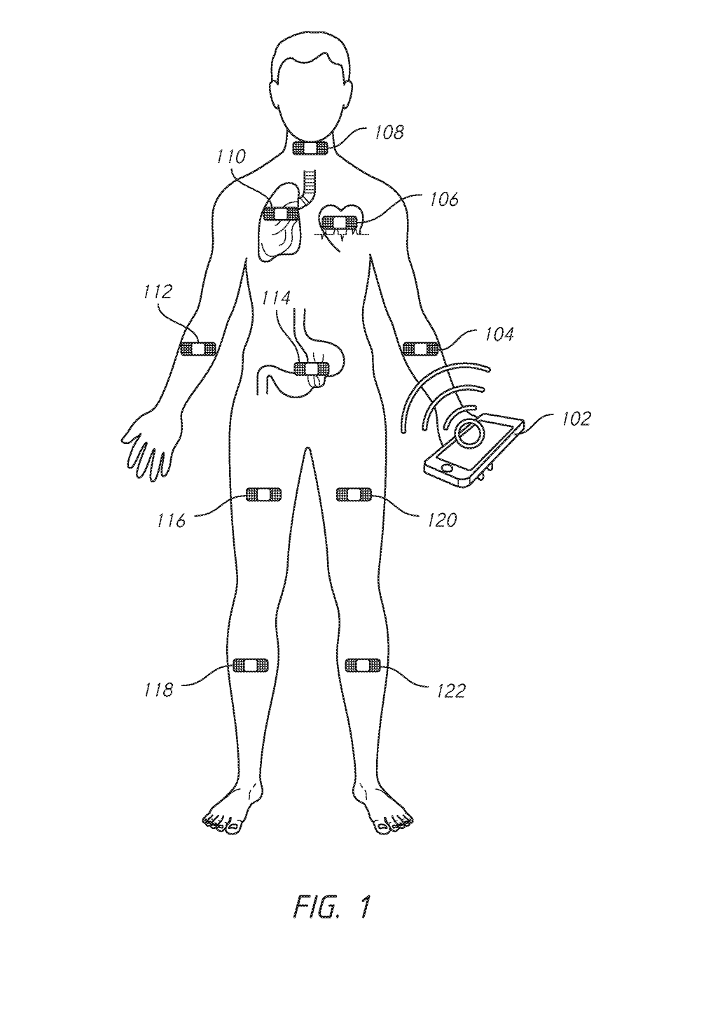

FIG. 1 is a schematic illustration of a system including multiple sensor devices on a body powered by a power device arranged in accordance with examples described herein. FIG. 1 illustrates a power device 102, and sensor devices 104, 106, 108, 110, 112, 114, 116, 118, 120, and 122. While 10 sensor devices are shown in FIG. 1, any number may be present in examples described herein, including 1, 2, 3, 4, 5, 6, 7, 8, 9, 10 or more sensor devices.

The power device 102 may include a power source and a power electrode. The power electrode may be coupled to the power source and may provide an electrical connection to a waveguide (e.g. the body). The power device may in some examples be implemented using a specialized device. In some examples, an electronic device may be used to implement the power device. Examples of electronic devices which may be used include, but are not limited to, mobile phones, tablets, computer systems, or combinations thereof.

The power device 102 may include a power source. Generally, any power source may be used such as one or more batteries, energy storage capacitors, energy harvesting circuitry for power harvesting from an environment, or combinations thereof. In some examples, the power source may be wholly or partially a conventional utility system (e.g. the power device may be plugged into a wall or auxiliary outlet).

The power device 102 may include a power device electrode. The power device electrode may be coupled to the power source and may provide electrical connection to a waveguide (e.g. the body). The power device electrode may be implemented using a conductive material positioned to be proximate the skin of the body when held or positioned proximate the body by a user. The power electrode, for example, may have electrical connection to the body even if separated from the body in some examples by other materials on the body such as a pocket, purse, clothing, glove, or combinations thereof. Electric fields provided by the power electrode may couple to the waveguide (e.g. body) through barriers (such as the pocket, purse, clothing, or glove) in some examples, providing the electrical connection to the waveguide (e.g. body). Any number of power device electrodes may be provided including 1, 2, 3, 4, 5, 6, 7, 8, 9, 10, or more power device electrodes. In some examples, 2 power device electrodes are provided to provide an alternating electric field.

In some examples, the power device may be implemented using a near-field communication device (e.g. a device configured for near-field communication). Examples include mobile phones having near-field communication capability (e.g. software, firmware, and/or hardware to support NFC). NFC generally refers to a transmission technique that uses coils oscillating at 13.56 MHz to achieve inductive coupling. As a protocol, NFC has several attractive features, for example, it is becoming increasingly common on smartphones, it may allow for simultaneous wireless power transfer and communication, and/or it may be unrestricted and considered safe for human exposure by the FCC.

In some examples, the coil of the NFC module included in smartphones may serve as an electrode (e.g. a power electrode) when placed proximate the skin, and BAN waveguide communication (e.g. communication through a waveguide, such as a body) can be achieved in some examples with a single electrode per device. Accordingly, in some examples, an unmodified NFC enabled smartphone placed proximate the skin may transmit a signal through the body that can be used to power one or more sensor device(s) described herein.

By using an unmodified smartphone to power body coupled devices in some examples, issues that may have been hindering and/or preventing practical application of BAN, such as the previous need for an inconvenient signal generator, may be addressed in some examples.

The NFC included in most devices may be designed to function using inductive coupling, which may rely on producing a magnetic field. However, the permeability of the human body may be comparable to that of air, so a BAN may not extend the range of a magnetic transmission. In examples described herein, NFC hardware may provide an electric field which when transmitted through the body may be strong enough to power sensor devices described herein. This powering may be advantageous in some examples because frequencies in the 10 MHz range (including 13.56 MHz) may be advantageous for BAN use. In this manner, in some examples, a communication range of NFC may be extended, allowing communication with multiple devices simultaneously (e.g. between power device 102 and any and/or all of the sensor devices shown and described with reference to FIG. 1).

The power device may include a transducing coil that may transduce a magnetic field provided by NFC into an electric field provided to one or more electrodes (e.g. a power device electrode). The transducing coil may be implemented, for example, using a planar conductive coil. Accordingly, in some examples, a battery of a near-fiend communication device may power magnetic fields provided in accordance with near-field communication techniques. The magnetic fields may be transduced by a transducing coil to electric fields provided to one or more power device electrodes.

In some examples, the transducing coil and/or power device electrode(s) may be provided in a case for an electronic device used to implement the power device (e.g. a case for a mobile phone or other near-field communication device).

The electric field generated by a near field communication (NFC) enabled smartphone placed in proximity to a person's arm, for example, has been found to propagate through the body with sufficient strength to provide power to a capacitively-coupled device on the other arm. Accordingly, sensor devices described herein may harvest power from and communicate with a power device (e.g. an unmodified smartphone in some examples) at extended ranges. For example, extended ranges would include ranges greater than 10 cm, which is the standard range or limit for operation of NFC devices. In other examples, other distances may be used, including communication at 1 cm or closer, 2 cm or closer, 3 cm or closer, 4 cm or closer, 5 cm or closer, 6 cm or closer, 7 cm or closer, 8 cm or closer, 9 cm or closer, 10 cm or closer, 12 cm or closer, 15 cm or closer, 20 cm or closer, or longer ranges in some examples. In some examples, power harvesting and/or communication may occur generally between any two points on, in, or proximate a body (e.g. which may be several feet in some examples).

Example power devices described herein may include software and/or firmware which support BAN communication and/or power transmission and harvesting described herein. For example, NFC firmware and/or software may be provided on a smartphone or other NFC device which may modify the NFC protocol to support a communication scheme with the sensor devices described herein (e.g. backscatter communication). In some examples, power devices may include filtering and/or machine learning software for filtering noise introduced by using the body as a communication channel. In some examples, a power device (e.g. a smartphone) may include software for one or more user interfaces for access to data collected from sensor devices. Note that data received by a power device from sensor devices described herein may be used locally and/or communicated to other electronic devices (e.g. computing systems, over the Internet, etc.) for storage, display, analysis, alert, and/or other functions.

The sensor devices 104, 106, 108, 110, 112, 114, 116, 118, 120, and 122 may each include sensor circuitry, power harvesting circuitry, and at least two sensor device electrodes. More than two sensor device electrodes may be used in some examples.

Examples of sensor devices may be in electrical communication with waveguides (e.g. bodies) described herein. For example, sensor devices (including those depicted in FIG. 1) may be placed on a body (e.g. strapped, adhered, worn, attached, and/or carried by the body). In some examples, one or more sensor devices may be implanted in the waveguide (e.g. body). As shown in FIG. 1, example sensor devices may include a flexible substrate and an adhesive region such that they may be adhered to the body (e.g. similar to a “Band-Aid”).

Each sensor device may have at least two sensor device electrodes. Generally, one of the sensor device electrodes, a first sensor device electrode, may make electrical connection to the waveguide (e.g. body). For example, one sensor device electrode may be positioned so that it contacts the skin or other portion of the body when the sensor device is positioned on or in the body. In this manner, there may be a first electrical path (e.g. a forward path) from the power device 102 to the first sensor device electrode. Electrical fields may be transmitted from the power device 102 (e.g. from one or more power device electrodes) to the first sensor device electrode through the waveguide (e.g. through the body).

Generally, another of the sensor device electrodes, e.g. a second sensor device electrode, may provide a return path from the sensor device to the power device. Return electrical signals (e.g. electrical fields, currents) may be provided from the second sensor device electrode back to the power device 102, e.g. to one of the power device electrodes. In this manner, a circuit may be formed between each sensor device and the power device.

In some examples, the second device electrode (e.g. the electrode forming the return path to the power device) may be positioned above the waveguide (e.g. the body) in proximity to the first sensor device electrode. For example, the first sensor device electrode may be positioned on the skin, and the second sensor device electrode may be a floating electrode that is positioned a distance above the skin. The return path between the floating electrode and the power device may accordingly be through the environment (e.g. the air).

In some examples, the second device electrode (e.g. the electrode forming the return path to the power device) may not necessarily be a floating electrode. The second device electrode may be positioned on a substrate supporting the first device electrode and/or other components. In some examples, the second device electrode may be exposed to the environment. During use, a portion of the waveguide may contact the second device electrode, forming the return path through the portion of the waveguide that contacts the second device electrode. For example, a finger or other portion of the body may contact the second device electrode (e.g. a user may touch the second device electrode), forming the return path.

In some examples, the first and second device electrodes may both be in contact with the waveguide (e.g. the body), but may be separated on a substrate supporting components of the sensor device. By providing sufficient distance between the electrodes, the path between the first electrode and the power device will be a different length than the path between the second electrode and the power device, allowing for the forward and return paths. Examples having two electrodes at opposite ends of a substrate, for example, that may both come into contact with a portion of the body, may be particularly suitable for use as implanted sensor devices, because a user does not need to touch an electrode to form a return path, nor may a return path through the environment be required.

Each sensor device may include power harvesting circuitry. The power harvesting circuitry may harvest power from the power source of the power device through at least the first sensor device electrode. For example, the power harvesting circuitry may extract power from the electrical signals transmitted through the waveguide (e.g. the body) from the power device. The power harvesting circuitry may provide power to other components of the sensor device using the harvested power—including sensing circuitry and/or communication circuitry, such as wireless communication circuitry.

Examples of sensor devices described herein may include electrical components (e.g. electrodes, sensing circuitry, power harvesting circuitry, and/or communication circuitry) supported by a substrate. Any of a variety of substrate materials may be used, for example printed circuit boards. In some examples, flexible substrate materials may be used (e.g. polymers). In some examples, the substrate may have an adhesive region to allow application of the sensor device to a waveguide (e.g. a body).

Any of a variety of sensor circuitry (e.g. sensors) may be included in the sensor devices described herein. Examples of sensing circuitry include dielectric pressure sensors, which may detect a pulse rate. Examples of sensing circuitry include ECG sensors which may detect a heart rate of the body. Other examples of sensing circuitry include accelerometers (e.g. to detect chest movement), microphones (e.g. to detect gut sounds), temperature detectors, moisture detectors, humidity detectors, pH detectors, or combinations thereof.

In operation, body area sensor devices described herein may be powered by power harvested from one or more power devices. A power device may be brought into proximity with the body such that electrical signals from the power device may be coupled to the body. Energy may be harvested from those electrical signals by the sensor devices. In some examples, a portion of the body may contact the sensor device to initiate and/or halt a charging process. The harvested energy may be used by the sensor devices for generally any purpose including, but not limited to, sensing, communicating, storing data, displaying indicators, or combinations thereof.

Accordingly, in example systems, sensor devices (e.g. sensors in a simple adhesive bandage-like package) may be placed around the body may provide a variety of health sensing data to another device (e.g. power device 102).

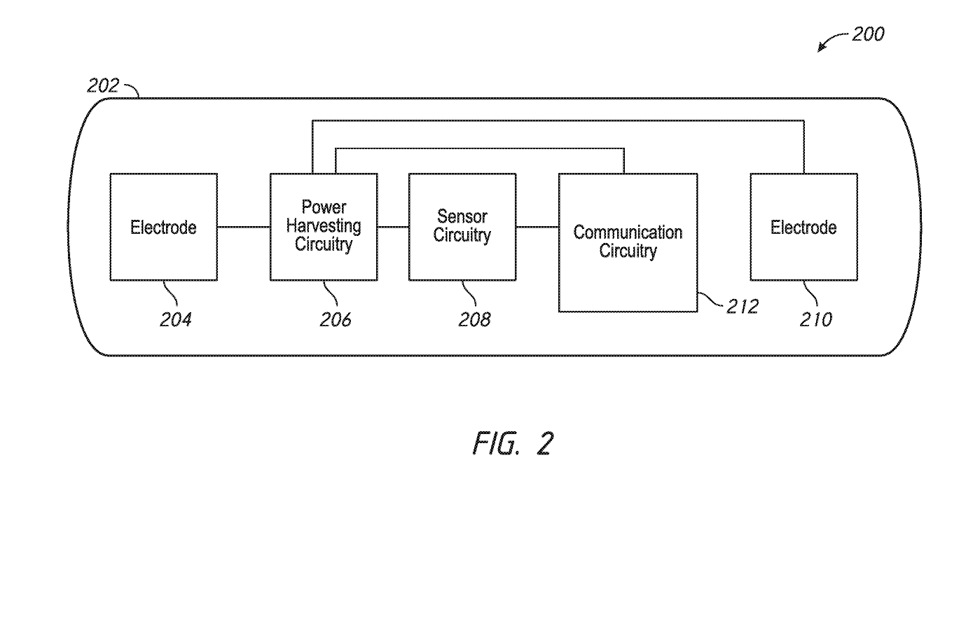

FIG. 2 is a schematic illustration of a sensor device arranged in accordance with examples described herein. The sensor device 200 includes substrate 202, electrode 204, power harvesting circuitry 206, sensor circuitry 208, electrode 210, and communication circuitry 212. In other examples, fewer, additional, and/or different components may be included in the sensor device 200. The sensor device 200 may be used to implement and/or be implemented using any of the sensor devices shown and described with reference to FIG. 1 in some examples.

The sensor device 200 includes a substrate 202. The substrate may generally be implemented using any substrate materials suitable for supporting the components described. For example, the substrate 202 may be implemented using a printed circuit board, and the electrode 204, power harvesting circuitry 206, sensor circuitry 208, electrode 210, and/or communication circuitry 212 may be mounted on and/or otherwise supported by the printed circuit board. In some examples, the substrate 202 may be implemented using a flexible substrate, such as a polymer substrate. The electrode 204, power harvesting circuitry 206, sensor circuitry 208, electrode 210, and/or communication circuitry 212 may be mounted on and/or otherwise supported by the flexible substrate.

In some examples, the substrate 202, which may be a flexible substrate, may include an adhesive region. The adhesive region may facilitate adhering the sensor device 200 to a waveguide (e.g. a body). Other attachment mechanisms may be incorporated in and/or coupled to the substrate 202 including, but not limited to, straps, Velcro, hooks, or combinations thereof.

The substrate 202 may have any of a variety of shapes. In some examples, the substrate 202 may have an oblong shape (e.g. similar to a Band-Aid). Adhesive regions may be present on ends of the oblong shape (e.g. similar to a Band-Aid) while components are mounted or otherwise positioned on an interior portion of the oblong shape, or an opposite side from the adhesive regions.

The sensor device 200 may include electrodes, such as electrode 204 and electrode 210. Any number of electrodes may be included in some examples. The electrode 204, which may be a first sensor device electrode, may be supported by the substrate 202 and may be positioned such that it may contact a portion of a waveguide (e.g. a body) when the substrate 202 is positioned proximate the waveguide and/or adhered to the waveguide. For example, the electrode 204 may be placed against a skin of a body when the substrate 202 is adhered to the body. Accordingly, the electrode 204 may be positioned on a side of the substrate 202 that will face the waveguide (e.g. body) during use. The electrode 204 may be exposed to the environment such that it may make direct contact with the waveguide (e.g. body) during use. The electrode 204 may be included in a forward path for electrical signals (e.g. electrical fields) between a power device, such as the power device 102 of FIG. 1, and the sensor device 200.

The electrode 210, which may be a second sensor device electrode, may be supported by the substrate 202 in some examples, and may be positioned to provide a return path from the sensor device 200 to a power device, such as the power device 102 of FIG. 1. The forward and return paths may be between the sensor device 200 and a power source of the power device in some examples. The electrode 210 may accordingly be provided in any of a variety of configurations to provide the return path.

For example, the electrode 210 may be positioned above the substrate 202 in some examples and may be a floating electrode, providing a return path through an environment (e.g. the air). The floating electrode may not be electrically coupled to the waveguide (e.g. body), and/or may be poorly coupled to the waveguide (e.g. body) in some examples. In some examples, the floating electrode may be positioned a distance from the body such that the electrode is not coupled and/or is poorly coupled to the body. In some examples, a geometry may be used that may reduce and/or prevent the floating electrode coupling to the waveguide. For example, a wire attached to the electrode and extending generally perpendicular to the body may improve coupling to the environment while reducing coupling to the body.

In some examples, the electrode 210 may be positioned close to the electrode 204 (e.g. on an opposite side of the substrate 202) and may provide a return path when a portion of the waveguide (e.g. a finger of a body) contacts the electrode 210. In this manner, contact with the waveguide may be able to initiate, halt, and/or change a rate of power harvesting and/or communication.

In some examples, the electrode 210 may be positioned on an opposite end of the substrate 202 from the electrode 204 (e.g. as shown in FIG. 2). The electrode 210 may be positioned to contact the waveguide as well (e.g. may be placed on a same side of the substrate 202 that will face the waveguide during use). The electrode 210 may make direct contact with the waveguide during use. At least because the electrode 204 and electrode 210 may contact the waveguide at different distances from a power device (e.g. the electrode 204 and electrode 210 may be separated by 10 cm or more in some examples, 15 cm or more in some examples, 20 cm or more in some examples), forward and return paths may be provided.

Generally, the electrode 204 and/or electrode 210 may be implemented using any conductive material. In some examples, copper may be used to implement electrode 204 and/or electrode 210.

The sensor circuitry 208 may also be supported by the substrate 202 (e.g. a flexible substrate) in some examples. The sensor circuitry 208 may be coupled to (e.g. in electronic communication with) the power harvesting circuitry 206 and/or the communication circuitry 212 in some examples. Any of a variety of sensors may be used to implement the sensor circuitry 208 including, but not limited to, dielectric pressure sensors, ECG sensors, accelerometers, pH sensors, humidity sensors, moisture sensors, or combinations thereof. The sensor circuitry may accordingly provide data regarding the waveguide (e.g. the body) to which the sensor device 200 is attached, adhered, mounted, or otherwise associated. For example, a sensor device including a dielectric pressure sensor may provide data indicative of pulse rate and/or blood pressure. A sensor device including an ECG sensor may provide data regarding heart rate. A sensor device including an accelerometer may provide data regarding respiratory rate (e.g. from chest movements). A sensor device including a microphone may provide data regarding gut activity (e.g. by sensing sounds produced by a gut). In some examples, the sensor circuitry 208 may provide data regarding an environment in which the sensor device 200 is located.

The power harvesting circuitry 206 may also be supported by the substrate 202 (e.g. a flexible substrate) in some examples. The power harvesting circuitry 206 may be coupled to (e.g. in electronic communication with) the electrode 204, electrode 210, and/or sensor circuitry 208 in some examples. The power harvesting circuitry 206 may at least partially power the sensor circuitry 208 and/or the communication circuitry 212 using power harvested form a power source of a power device, which may, for example, be provided through the electrode 204 and/or electrode 210.

The power harvesting circuitry 206 may include circuitry for harvesting power from electrical signals transmitted through a waveguide (e.g. through a body, from a power device). Examples of power harvesting circuitry may include a charge pump to amplify and/or rectify an input signal (e.g. a voltage received from the body). Examples of power harvesting circuitry may further include a capacitor (e.g. a supercapacitor) to store power.

The communication circuitry 212 may also be supported by the substrate 202 (e.g. a flexible substrate) in some examples. The communication circuitry 212 may be coupled to (e.g. in electronic communication with) the sensor circuitry 208 and/or power harvesting circuitry 206. In some examples, the power harvesting circuitry 206 may provide power to the communication circuitry 212. The communication circuitry 212 may transmit data collected by the sensor circuitry 208 in some examples. The communication circuitry 212 may additionally or instead receive data in some examples. For example, the communication circuitry 212 may transmit data collected by the sensor circuitry 208 to a power device as described herein, such as the power device 102 of FIG. 1. In some examples, the communication circuitry 212 may transmit data to other receiver(s). The communication circuitry 212 may implement wired and/or wireless communication. Any of a variety of components for communication may be included in communication circuitry 212, including but not limited to, antenna(s), encoder(s), decoder(s), transmitter(s), receiver(s), or combinations thereof.

In some examples, the communication circuitry 212 may make use of low or lower power data transmission techniques. In some examples, the communication circuitry 212 may include a backscatter transmitter which may backscatter one or more incident signals (e.g. incident wireless communication signals such as Wi-Fi, Bluetooth, TV or other broadcast signals) to communicate data. In some examples, the communication circuitry 212 may employ a Barker code to prevent and/or reduce bit loss. In some examples, communication provided by communication circuitry 212 may include an identification of a node from which the communication originated (e.g. identification of the sensor device originating the communication).

Examples of sensor devices described herein may further include energy storage components (e.g. capacitors) and/or memory for data storage. Examples of sensor devices described herein may further include one or more impedance matching circuits which may aid in impedance matching the sensor device to the waveguide (e.g. the body). Examples of sensor devices described herein may include one or more antennas for communication and/or coupling to the waveguide (e.g. body). In some examples, sensor devices may harvest around 200 micro amps at 1.8V. Other harvesting amounts and other voltages are possible in other examples.

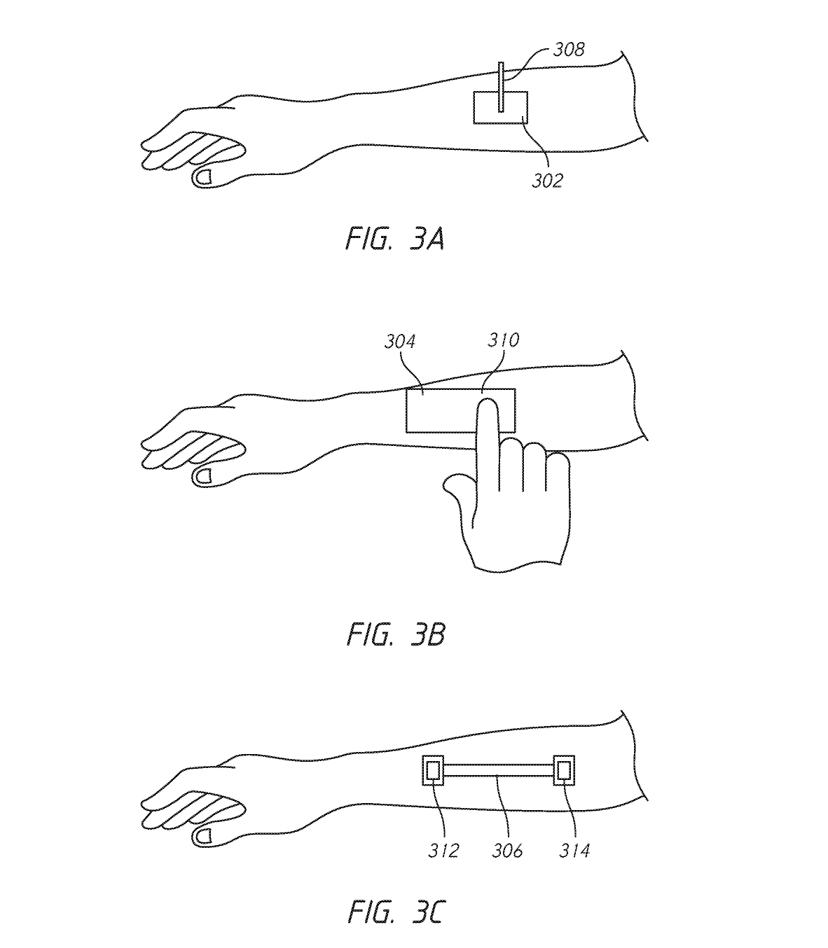

FIG. 3A-FIG. 3C are schematic illustrations of sensor devices positioned on an arm in accordance with examples described herein. FIG. 3A illustrates sensor device 302 having sensor device electrode 308. FIG. 3B illustrates sensor device 304 having sensor device electrode 310. FIG. 3C illustrates sensor device 306 having sensor device electrode 312 and sensor device electrode 314. FIG. 3A-FIG. 3C are provided to aid in understanding some examples of positioning a second sensor device electrode to provide a return path to a power device. Accordingly, other components of the sensor devices may not be explicitly shown in FIG. 3A-FIG. 3C. For example, a first sensor device electrode may generally be provided that may contact a skin of the arm and provide a forward path to a power device.

Generally, the sensor device 302, sensor device 304, and/or sensor device 306 may be used to implement and/or may be implemented by example sensor devices described herein, including any of the sensor devices shown in FIG. 1 and/or sensor device 200 of FIG. 2.

The sensor device 302 of FIG. 3A includes a sensor device electrode 308 which may form part of a return path to a power device in accordance with examples described herein. The sensor device electrode 308 may be a floating electrode and may be positioned above a surface of the sensor device 302 and waveguide (e.g. arm as shown in FIG. 3A). The sensor device electrode 308 may be a post, as shown, or may be a planar electrode elevated above the sensor device 302 in some examples. A return path may be provided form the sensor device electrode 308 through the environment back to a power device, such as the power device 102 of FIG. 1.

The sensor device 304 of FIG. 3B includes a sensor device electrode 310 which may form part of a return path to a power device in accordance with examples described herein. The sensor device electrode 310 may be exposed for contact by a portion of the waveguide (e.g. by a finger as shown in FIG. 3B). The sensor device electrode 310 may be on an opposite side of a substrate forming the sensor device 304 and may be positioned in proximity to a first sensor device electrode, which may, for example, be in direct contact with the waveguide (e.g. skin of the arm) during use. The return path may be provided from a power device, through the finger and sensor device electrode 310 in the example of FIG. 3B. Because a different distance may be provided between a power device and a first sensor device electrode, e.g. which may be positioned against the skin in FIG. 3B, than a distance between the power device and the sensor device electrode 310, the forward and return paths may have different resistances.

The sensor device 306 of FIG. 3C includes a sensor device electrode 314 which may form part of a return path to a power device in accordance with examples described herein. The sensor device electrode 314 may be positioned to be in direct contact with a portion of the waveguide (e.g. the arm) in examples described herein, and may be placed a distance away on the sensor device 306 from another electrode, e.g. sensor device electrode 312. The sensor device electrode 312 may form part of a forward path to the power device. Because the distance between the power device and the sensor device electrode 312 and sensor device electrode 314 may be different, the forward and return paths may have different resistances. The sensor device 306 having separated electrodes which may not require either access to the environment to form a return path or contact from another portion of the waveguide, may be advantageous for implant in the waveguide (e.g. implant in the body).

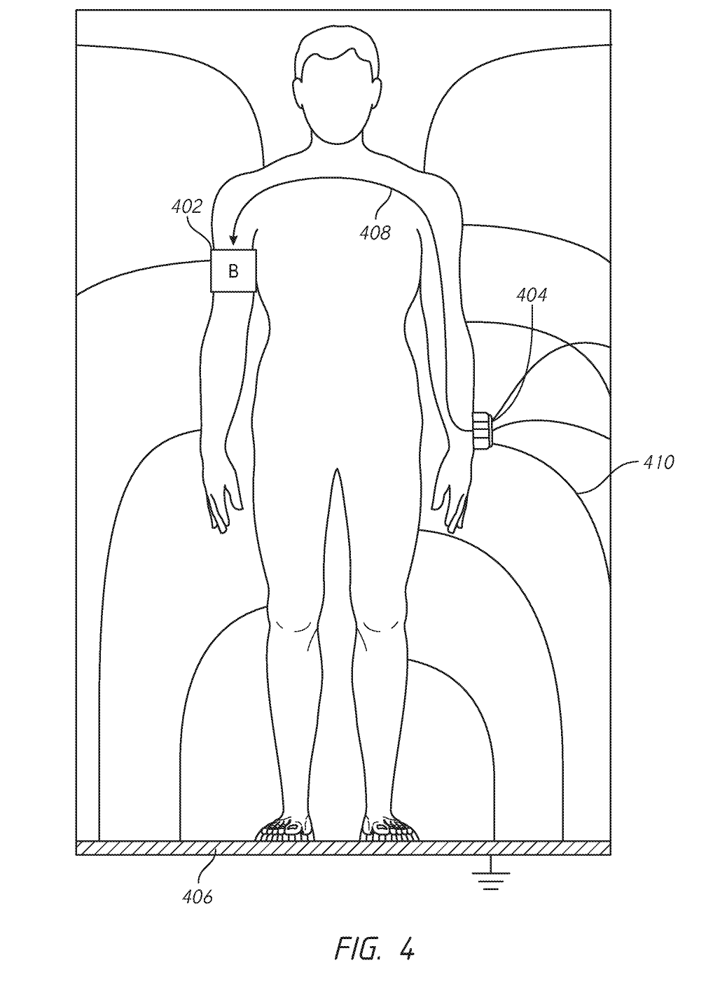

FIG. 4 is a schematic illustration of example forward and return paths arranged in accordance with examples described herein. FIG. 4 illustrates a power device 404, sensor device 402, ground 406, forward path 408, and return path 410. In other examples, additional, fewer, and/or different components may be present.

The power device 404 may be implemented using and/or may be used to implement any of the power devices described herein. The sensor device 402 may generally be used to implement and/or may be implemented using example sensor devices described herein having a floating electrode.

The power device 404 is shown worn on a user's wrist (e.g. may be a smartwatch form factor). The power device 404 may include a power source, as described herein. The sensor device 402 is shown worn on a user's arm. The sensor device 402 may include a floating electrode that may be distanced from the body and may provide a return path (e.g. a portion of return path 410 is labeled) to the power device 404 through the environment. For example, the return path 410 may include a path between the sensor device 402 and ground 406, and the power device 404 may share a same ground 406. In this manner, a return path 410 may be provided through the environment. A forward path 408 is present through the body between the power device 404 and the sensor device 402.

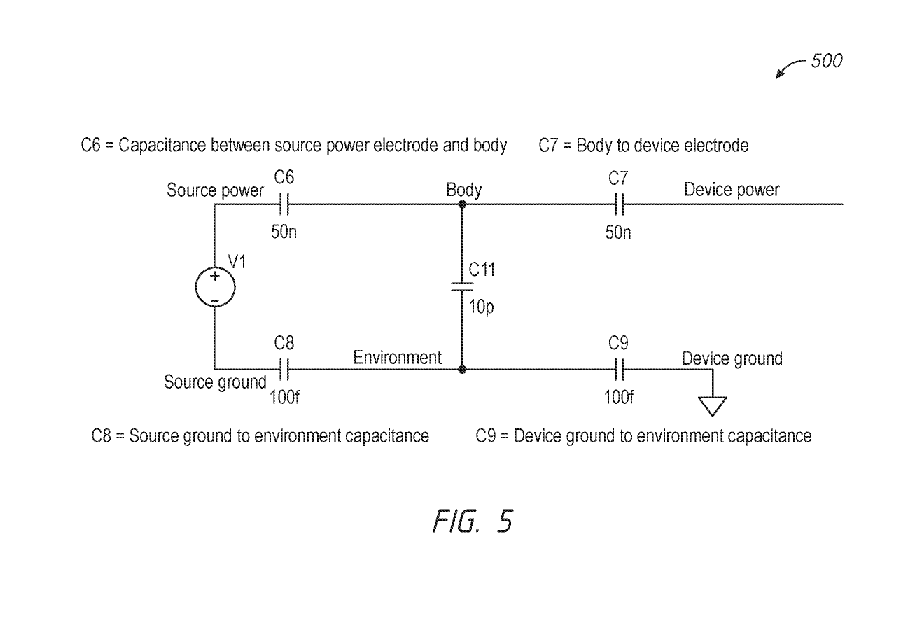

FIG. 5 is a schematic illustration of a circuit representation of an example system arranged in accordance with examples described herein. The circuit representation of FIG. 5 pertains to example systems having a floating electrode and providing a return path through the environment, such as the system shown in FIG. 4.

A power source of a power device is represented as V1. The power source may be coupled to a body through a capacitance, C6, between a power device electrode and the body. The power source's ground may be coupled to the environment by a capacitance, C8, between the ground to the environment. The body may be coupled to the environment through a capacitance C11. A sensor device electrode may be coupled to the body by a capacitance C7 between the sensor device electrode and the body. The sensor device ground may be coupled to the environment by the capacitance C9 between the sensor device ground and the environment.

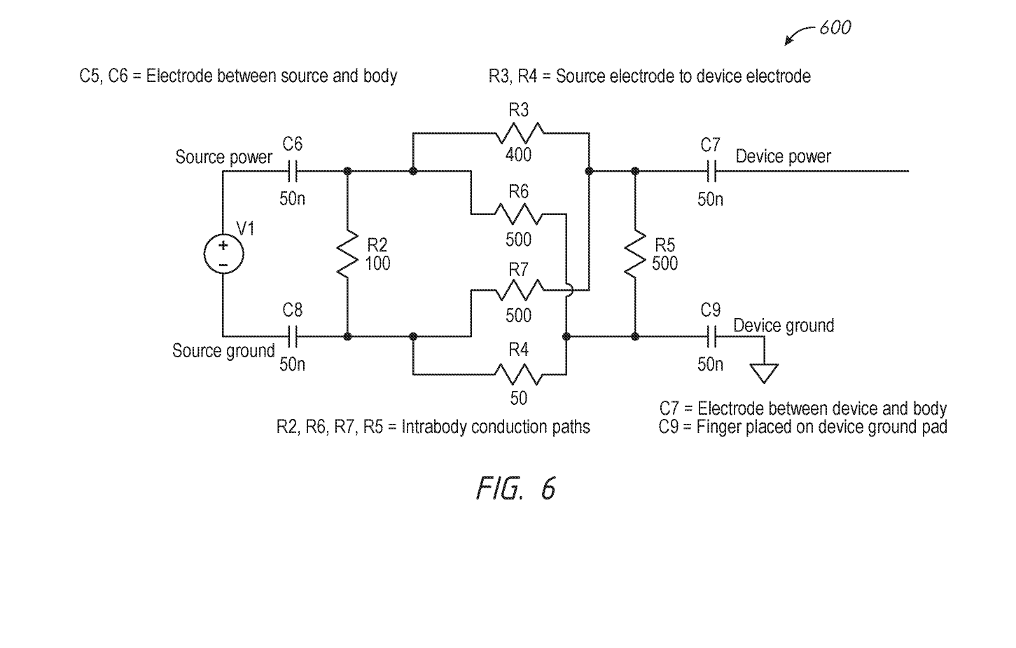

FIG. 6 is a schematic illustration of a circuit representation of an example system arranged in accordance with examples described herein. The circuit representation of FIG. 6 pertains to example systems where a return path may be provided by a portion of the waveguide (e.g. body) contacting at least one of the sensor device electrodes.

A power source of a power device is represented as V1. The power source may be coupled to a body through a capacitance, C6, between a power device electrode and the body. The power source's ground may be coupled to the return path by a capacitance, C8, between the ground to return path. R3 and R4 represent resistances between a power device electrode and a sensor device electrode. R2, R6, R7, and R5 represent intrabody conduction paths. A sensor device electrode may be coupled to the body by a capacitance C7 between the sensor device electrode and the body. The sensor device ground may be coupled to a return path by the capacitance C9 between the sensor device ground and the return path, which may include capacitance associated with a portion of the waveguide (e.g. a finger) placed on a sensor device electrode (e.g. a ground electrode).

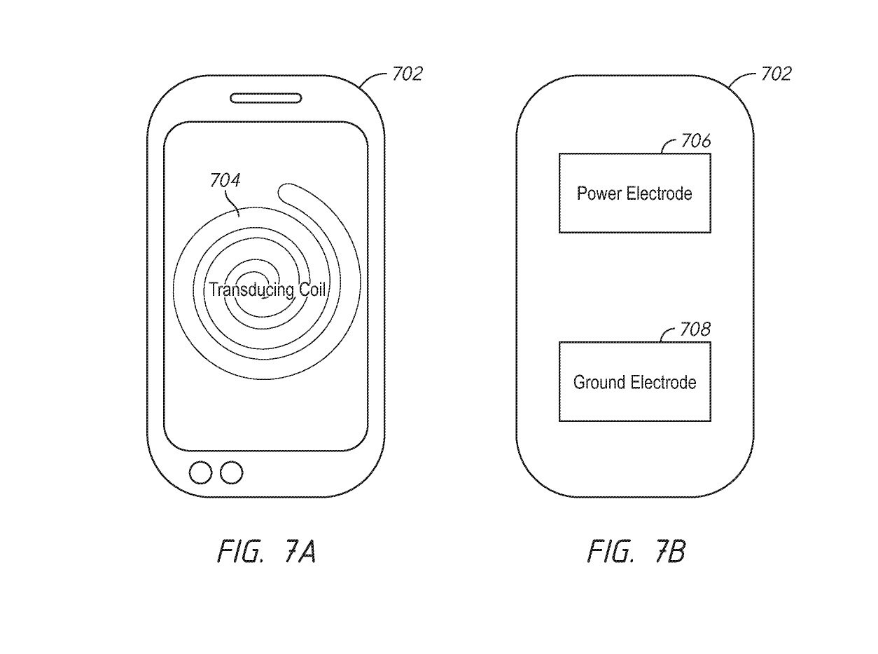

FIG. 7A and FIG. 7B are schematic illustrations of a case arranged in accordance with examples described herein. FIG. 7A is a view of the front side of the case. FIG. 7B is a view of the back side of the case. The case may include housing 702, transducing coil 704, power device electrode 706, and power device electrode 708. In other examples, additional, fewer, or other components may be used.

Example cases may include housings, such as housing 702. The housing may attach to an electronic device. For example, the housing may completely or partially define an opening sized to receive the electronic device. In some examples, the housing may include straps, adhesives, or other connectors for attachment to an electronic device. For example, the housing 702 may attach to and/or be part of power devices described herein, such as power device 102 of FIG. 1 and/or power device 404 of FIG. 4.

Generally, any electronic devices may be attached to example cases described herein. Example electronic devices include, but are not limited to, mobile phones, tablets, computing systems, or combinations thereof. In some examples, electronic devices described herein may provide near-field communications. For example, the electronic device may include hardware, firmware, and/or software for providing near-field communication.

Example cases described herein may include one or more transducing coils, such as transducing coil 704. The transducing coil 704 may receive a magnetic field provided by the electronic device (e.g. provided by near-field communication). The transducing coil 704 may convert (e.g. transduce) the magnetic field into an electric field.

Example cases described herein may include one or more electrodes, such as power device electrode 706 and power device electrode 708. One or more of the electrodes may be a ground electrode. The electrodes may be coupled to the transducing coil 704 and may receive an electric field provided by the transducing coil 704 and provide an alternating electric field based on the magnetic field received by the transducing coil 704. Generally, the power device electrodes may be positioned to couple to a waveguide (e.g. a body) as described herein.

In some examples, transducing coils may be provided on one side of a housing while power device electrodes may be positioned on an opposite side of the housing. For example, the transducing coil 704 may be positioned on a side of the housing 702 facing an area that may receive an electronic device (e.g. a mobile phone) during use. Power device electrode 706 and power device electrode 708 may be positioned on an opposite side of the housing 702 facing an area that may be positioned proximate a waveguide (e.g. a body) during use. Other locations and shapes for the transducing coil 704 and/or power device electrode 706 or power device electrode 708 may also be provided. The power device electrode 706 and/or power device electrode 708 may be in electrical communication with a body when the housing 702 is held by the body, placed on the body, or carried by the body (including, for example, in a pocket or purse).

Examples of transducing coils may be advantageous for use with NFC communication devices, or other power devices producing magnetic fields because the human body may generally be good at conducting electric fields but not as good at passing magnetic fields. Accordingly, it may be desirable to transduce a magnetic field produced by a power device into an electric field to be coupled to a body, e.g. through capacitive coupling.

In some examples, during normal use, using inductive coupling at a range of less than 10 cm, NFC may be able to transfer approximately 6 milliamps of current at 1.7 volts. Other currents, voltages, and distances, may be possible in other examples.

In use, the case of FIG. 7 may be attached to an electronic device (e.g. a smartphone). In some examples, a case may not be needed and transducing components may be integrated into the power device (e.g. a smartphone).

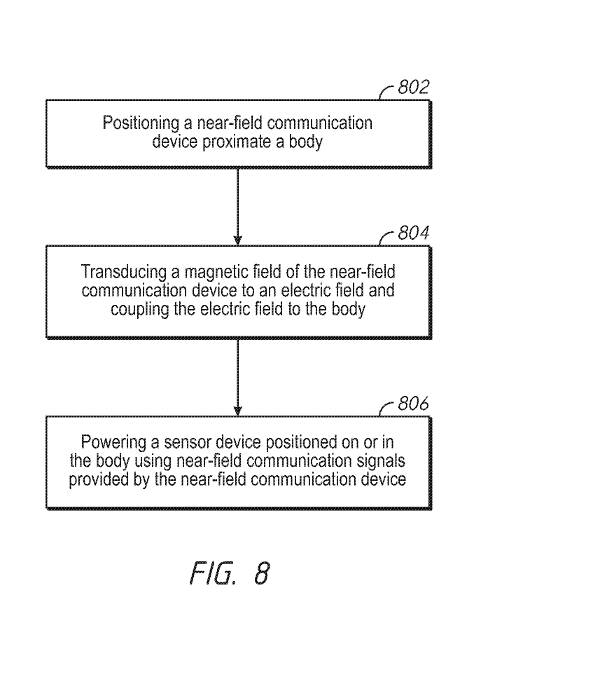

FIG. 8 is a flowchart illustrating a method arranged in accordance with examples described herein. The method of FIG. 8 includes positioning a near-field communication device proximate a body in block 802 followed by transducing a magnetic field of the near-field communication device to an electric field and coupling the electric field to the body in block 804 powering a sensor device positioned on or in the body using near-field communication signals provided by the near-field communication device in block 806. In some examples, additional, fewer, and/or different blocks may also be included, and the blocks may occur at least partially simultaneously in some examples.

In block 802, a near-field communication device is positioned proximate a body (or other waveguide in some examples). The near-field communication device may be attached to a case in some examples, such as the case of FIG. 7. While a near-field communication device is mentioned in FIG. 8, in some examples, other power devices may be used, such as one or more power devices described herein. Generally, the power device may couple an electrical signal (e.g. an electric field) to the waveguide (e.g. body).

In block 804, a magnetic field provided by the near-field communication device may be transduced to an electric field. The electric field may be coupled to the body (e.g. using one or more transducing coils and electrodes, such as those shown and described in a case in FIG. 7). The method may include coupling a case including one or more transducing coils and/or electrodes to a near-field communication device.

In block 802, the near-field communication device (or other power device(s) in some examples) may be positioned proximate a body such that electrical signals caused by the near-field communication device may be coupled to the body. For example, the near-field communication device (or other power device(s)) may be held by the body (e.g. in a hand), carried on the body (e.g. strapped to an arm, worn on a belt, around the neck), implanted in the body, and/or placed in a pocket, purse, or other carrying location proximate the body.

Generally, the positioning of block 802 may allow for one or more power device electrodes (e.g. power device electrode 706 and/or power device electrode 708 of FIG. 7) to be in close proximity to the skin. For example, power device electrodes may be positioned within 5 cm of the skin, within 4 cm of the skin, within 3 cm of the skin, within 2 cm of the skin, within 1 cm of the skin, within 0.5 cm of the skin, or in contact with the skin in some examples. This may allow the power device electrode(s) to couple to the body and the sensor devices, which can be considered to treat the body as a capacitor. During use, a transducer, such as the transducing coil 704 of FIG. 7, may convert a magnetic NFC signal into an electric one which may be injected into the body through capacitive coupling via the power device electrode(s).

In block 806, a sensor device may be powered using the near-field communication signals from the near-field communication device. For example, a sensor device may be powered by extracting power from electrical signals (e.g. electric fields) transmitted to one or more electrodes of the sensor device through a waveguide (e.g. a body). In some examples, sensor devices may generally be powered using electrical signals extracted from a waveguide (e.g. body) that originated from a power device.

Any number of sensor devices may be powered in accordance with block 806. Example sensor devices described herein may be powered in block 806, such as any of the sensor devices described and shown with reference to FIG. 1, sensor device 200 of FIG. 2, or other sensor devices described and/or shown herein.

Harvesting circuitry included in and/or in communication with the sensor devices may harvest power from electrical signals delivered through the body from the power device to the sensor device.

Powering the sensor device in block 806 may include providing a forward path and a return path between the sensor device and one or more power device(s), such as a near-field communication device. In some examples, powering the sensor device may include touching the sensor device with a portion of the body (e.g. a finger) to provide a forward and/or return path.

In some examples, the sensor device powered in block 806 (and/or other sensor device(s) described herein) may transmit data to a power device, such as the near-field communication device positioned proximate the body in block 802. In some examples, the sensor device powered in block 806 (and/or other sensor device(s) described herein) may transmit data to another electronic device and/or computing system. In some examples, the sensor device may communicate using backscatter. For example, the sensor device may include an antenna and one or more switches coupled to the antenna. The switches may be used to modulate an impedance of the antenna in accordance with data to be transmitted, thereby backscattering an incident signal. The incident signal may be provided by a power device, including a power device used to power the backscattering sensor device, or by another electronic device positioned to provide an incident signal to the sensor device. In some examples, ambient signals (e.g. Wi-Fi, Bluetooth, broadcast signals) may be backscattered by sensor device(s) described herein.

Examples of systems described herein may be utilized in a wide array of applications. A number of sensor devices may be positioned on and/or implanted in a user. The sensor devices may be powered by a power device described herein, and may communicate data back to the power device and/or another computing system. In some examples, data is first communicated to the power device which in turn communicates with other devices (e.g. over the Internet). In this manner, a variety of health data may be obtained from a user. In some examples, some data processing may occur on the sensor device(s). In other examples, raw data may be communicated from the sensor device(s) to the power device and/or another computing device which may in turn process and/or further process the data.

In one example application, sensor devices may be positioned on a body and may monitor coronary and respiratory activity. The sensor devices may provide data to a physician (e.g. by providing data to a computing device accessible to the physician). The data may be analyzed (e.g. using the sensor devices, other computing devices, and/or the physician) to identify and/or facilitate identifying episodes of sleep apnea. In this manner, body area networks described herein may be used to replace all or portions of existing in-hospital sleep apnea studies.

In another example application, a sensor device may be positioned to detect gut noise (e.g. proximate a user's gastrointestinal system), and another may be positioned to detect chest movement. Data regarding the gut noise and chest movement may be provided to a power device and/or other computing system and may be analyzed to alert a user when a harmful food has been ingested (e.g. when eating is occurring or has recently occurred and gut noises indicative of harmful food occur).

From the foregoing it will be appreciated that, although specific embodiments of the invention have been described herein for purposes of illustration, various modifications may be made without deviating from the spirit and scope of the invention.

What is claimed is:

1. A system comprising:
a power device comprising:
a power source; and
a power device electrode coupled to the power source and configured for electrical connection to a waveguide; and
a sensor device, the sensor device comprising:
sensor circuitry;
a first sensor device electrode configured for electrical connection to the waveguide;
a second sensor device electrode positioned to provide a return path from the sensor device to the power device; and
power harvesting circuitry coupled to the sensor circuitry, the first sensor device electrode, and the second sensor device electrode, the power harvesting circuitry configured to at least partially power the sensor circuitry using power harvested from the power source through at least the first sensor device electrode.

2. The system of claim 1, wherein the waveguide comprises a body.

3. The system of claim 1, wherein the power device comprises a mobile phone.

4. The system of claim 1, wherein the power device comprises an electronic device configured for near-field communication, the power source comprises a battery of the electronic device, and the power device electrode is coupled to a transducing coil of the electronic device.

5. The system of claim 4, wherein the transducing coil and the power device electrode are provided in a case for the electronic device.

6. The system of claim 4, wherein the sensor device is positioned at least 20 cm away from the power device on the waveguide.

7. The system of claim 1, wherein the second sensor device electrode is configured to be positioned above the waveguide in proximity to the first sensor device electrode and the return path is through an environment.

8. The system of claim 1, wherein the second sensor device electrode is configured to provide the return path when a portion of the waveguide contacts the second sensor device electrode.

9. The system of claim 1, wherein the first sensor device electrode and the second sensor device electrode are separated by a distance such that a different resistance is provided between the first sensor device electrode and the power device than a resistance between the second sensor device electrode and the power device.

10. The system of claim 9, wherein the sensor device is configured for implant into the waveguide.

11. The system of claim 1, wherein the waveguide comprises a body and the sensor circuitry comprises at least one of a dielectric pressure sensor configured to detect a pulse rate of the body or an ECG sensor configured to detect a heart rate of the body.

12. A sensor device comprising:
a flexible substrate configured to adhere to a body;
sensor circuitry supported by the flexible substrate;
a first sensor device electrode supported by the flexible substrate and configured for placement against a skin of the body when the flexible substrate is adhered to the body;
a second sensor device electrode positioned to provide a return path from the sensor device to a power source; and
power harvesting circuitry coupled to the sensor circuitry, the first sensor device electrode, and the second sensor device electrode, the power harvesting circuitry configured to at least partially power the sensor circuitry using power harvested from the power source through at least the first sensor device electrode.

13. The sensor device of claim 12, wherein the second sensor device electrode is configured to provide the return path when a portion of the body contacts the second sensor device electrode.

14. The sensor device of claim 13, wherein the second sensor device electrode is positioned on an opposite side of the flexible substrate from the first sensor device electrode.

15. The sensor device of claim 12, wherein the sensor circuitry comprises a dielectric pressure sensor, an ECG sensor, an accelerometer, or combinations thereof.

16. The sensor device of claim 12, further comprising communication circuitry configured to transmit data collected by the sensor circuitry, receive data, or combinations thereof.

17. A method comprising:
positioning a near-field communication device proximate a body;
transducing a magnetic field of the near-field communication device to an electric field and coupling the electric field to the body; and
powering a sensor device positioned on or in the body using the electric field.

18. The method of claim 17, wherein powering the sensor device comprises touching an electrode of the sensor device.

19. The method of claim 17, wherein positioning the near-field communication device proximate the body comprises placing the near-field communication device in a pocket.

20. The method of claim 17, further comprising extracting at least a portion of the electric field from the body using the sensor device.

21. The method of claim 17, further comprising transmitting data from the sensor device to the near-field communication device.
